(19) United States
(12) Patent Application Publication
(10) Pub. No.: US 2025/0310627 A1
(43) Pub. Date: Oct. 2, 2025

(54) SYSTEMS, METHODS, AND MEDIA FOR MONITORING AND ENGAGING THREATS

(71) Applicants: Robert A. Foti, Stony Point, NY (US); Hewitt Gregory A. DePass, Yonkers, NY (US)

(72) Inventors: Robert A. Foti, Stony Point, NY (US); Hewitt Gregory A. DePass, Yonkers, NY (US)

(21) Appl. No.: 19/098,792

(22) Filed: Apr. 2, 2025

Related U.S. Application Data
(60) Provisional application No. 63/573,296, filed on Apr. 2, 2024.

(51) Int. Cl. H04N 23/56; G06V 10/141; G06V 10/82; G06V 20/52

(52) U.S. Cl. CPC H04N 23/56; G06V 10/141; G06V 10/82; G06V 20/52

(57) ABSTRACT

Mechanisms for monitoring and engaging threats include: receiving by a hardware processor an image captured by a camera; determining by the hardware processor that a threat is present in the image; and in response to determining that the threat is present in the image; causing a light source to illuminate at least part of the threat. In some embodiments, the mechanisms further include configuring the light source to impair the vision of and/or disorient the threat. In some embodiments, determining that the threat is present in the image includes using a machine learning algorithm to determine that the threat is present in the image. In some embodiments, determining that the threat is present in the image includes detecting a weapon in the image. In some embodiments, the mechanisms further include causing light from the light source to target a head region of the threat.

### CROSS-REFERENCE TO RELATED APPLICATION

This application claims the benefit of U.S. Provisional Patent Application No. 63/573,296, filed Apr. 2, 2024, which is hereby incorporated by reference herein in its entirety.

### BACKGROUND

Threats to life and safety are an unfortunate part of the world in which we live. For example, active shooters in public and semi-public spaces such as schools, workplaces, and government buildings occur far too frequently.

Existing mechanisms for monitoring locations for threats are inadequate in that they merely alert others to the presence of a threat but do not provide any mechanism to engage the threat.

Accordingly, new mechanisms for monitoring and engaging threats are desirable.

### SUMMARY

In accordance with some embodiments, mechanisms, such as systems, methods, and media, for monitoring and engaging threats are provided.

In some embodiments, systems for monitoring and engaging threats are provided, the systems comprising: a camera configured to capture an image; a hardware processor coupled to the camera; and a light source coupled to the hardware processor, wherein the hardware processor is configured to at least: receive the image; determine that a threat is present in the image; and in response to determining that the threat is present in the image; cause the light source to illuminate at least part of the threat. In some of these embodiments, the camera, the hardware processor, and the light source are contained in a single unit. In some of these embodiments, the light source is configured to impair the vision of and/or disorient the threat. In some of these embodiments, the hardware processor uses a machine learning algorithm to determine that the threat is present in the image. In some of these embodiments, the hardware processor determines that the threat is present in the image by detecting a weapon in the image. In some of these embodiments, the hardware processor is also configured to cause light from the light source to target a head region of the threat.

In some embodiments, methods for monitoring and engaging threats are provided, the methods comprising: receiving by a hardware processor an image captured by a camera; determining by the hardware processor that a threat is present in the image; and in response to determining that the threat is present in the image; causing a light source to illuminate at least part of the threat. In some of these embodiments, the method further comprises configuring the light source to impair the vision of and/or disorient the threat. In some of these embodiments, determining that the threat is present in the image comprises using a machine learning algorithm to determine that the threat is present in the image. In some of these embodiments, determining that the threat is present in the image comprises detecting a weapon in the image. In some of these embodiments, the method further comprises causing light from the light source to target a head region of the threat.

In some embodiments, non-transitory computer-readable media containing computer executable instructions that, when executed by a processor, cause the processor to perform a method for monitoring and engaging threats are provided, the method comprising: receiving an image captured by a camera; determining by the hardware processor that a threat is present in the image; and in response to determining that the threat is present in the image; causing a light source to illuminate at least part of the threat. In some of these embodiments, the method further comprises configuring the light source to impair the vision of and/or disorient the threat. In some of these embodiments, determining that the threat is present in the image comprises using a machine learning algorithm to determine that the threat is present in the image. In some of these embodiments, determining that the threat is present in the image comprises detecting a weapon in the image. In some of these embodiments, the method further comprises causing light from the light source to target a head region of the threat.

### BRIEF DESCRIPTION OF THE DRAWINGS

FIG. 1 is an example block diagram of an architecture for monitoring and engaging threats in accordance with some embodiments.

FIG. 2 is an example block diagram of hardware that can be used in one or more of the components of FIG. 1 in accordance with some embodiments.

FIG. 3 is an example illustration of a monitoring/engagement device in accordance with some embodiments.

FIG. 4 is an example flow diagram of a process that can be performed by one or more of a monitoring/engagement device, a server, and a user device in accordance with some embodiments.

### DETAILED DESCRIPTION

In accordance with some embodiments, mechanisms, such as systems, methods, and media, for monitoring and engaging threats are provided.

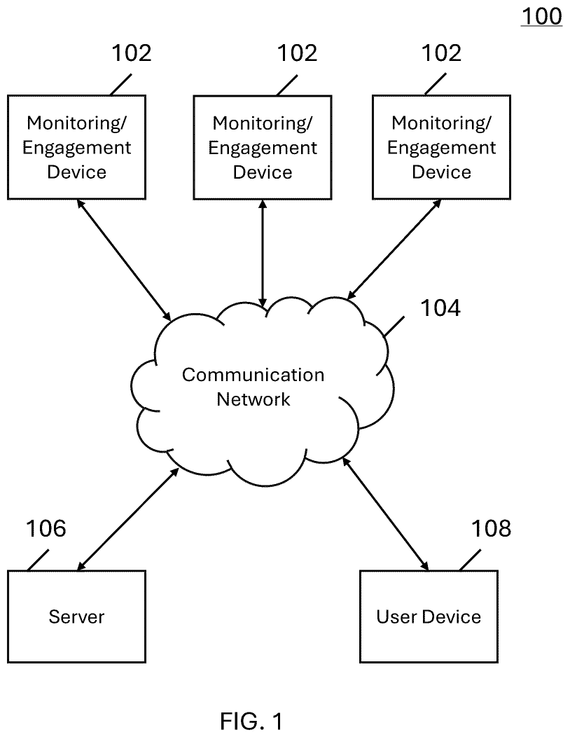

Turning to FIG. 1, an example 100 of an architecture for monitoring and engaging threats in accordance with some embodiments of the disclosed subject matter is shown. As illustrated, architecture 100 can include multiple monitoring/engagement devices, a communication network, a server, and a user device, in some embodiments. Although, three monitoring/engagement devices are shown in FIG. 1, any suitable number of these devices can be used in some embodiments. Although, one server and one user device are shown in FIG. 1, any suitable number of these devices (including none) can be used in some embodiments.

The components shown in FIG. 1 can be at any suitable one or more locations. For example, the monitoring/engagement devices can be located at one location (such as a school, library, post office, store, church, etc.) and the user device can be located at another location (such as a monitoring facility).

Any suitable additional or alternative devices, can be used in some embodiments. For example, one or more additional devices, such as servers, computers, routers, firewalls, gateways, networks, etc., can be included in some embodiments.

The monitoring/engagement device can be any suitable device for monitoring and/or engaging a threat, such as an armed intruder, a thief, or any other person, animal, or machine not authorized to be in a given location. For example, as described in further detail below, the monitoring/engagement device can be device that includes a camera, a dazzler light, a speaker, and a microphone for monitoring and engaging a threat in a given environment.

Communication network 108 can be any suitable combination of one or more wired and/or wireless networks, in some embodiments. For example, in some embodiments, communication network 108 can include any one or more of the Internet, a mobile data network, a satellite network, a local area network, a wide area network, a telephone network, a cable television network, a WiFi network, a WiMax network, and/or any other suitable communication network.

The server can be a device for performing any suitable functions based on data, video, images, audio, and/or any suitable information provided to or received from the monitoring/engagement devices and/or user devices. In some embodiments, the server can be omitted. For example, in some embodiments, as described further below, the server can be used to perform image/video processing on images/video captured by a camera of a monitoring/engagement device, to control a light source of the monitoring/engagement device, to control a speaker of the monitoring/engagement device, and/or to perform any other suitable function.

The user device can be used by a user to interact with the monitoring/engagement device(s) and/or server. For example, the user device can be used to display video/images captured by the monitoring/engagement device(s), to play audio captured by a microphone of the monitoring/engagement device(s), to capture audio to be played by a speaker of the monitoring/engagement device(s), to control a light of the monitoring/engagement device(s), and/or to perform any other suitable function. In some embodiments, the user device may connect to the monitoring/engagement device(s) through the server.

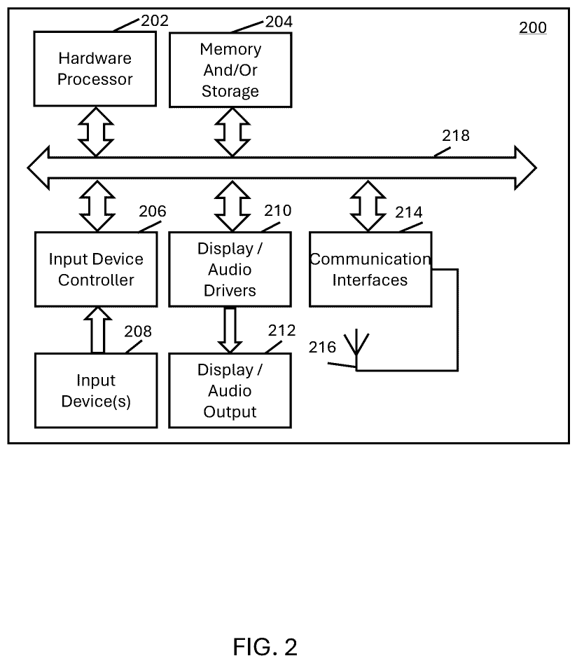

The monitoring/engagement devices, the server, and the user device can be implemented using any suitable hardware, in some embodiments. For example, in some embodiments, the server and/or user device can be implemented using any suitable general-purpose computer(s) or special-purpose computer(s). Any such general-purpose computer or special-purpose computer can include any suitable hardware, in some embodiments. For example, as illustrated in example hardware 200 of FIG. 2, such hardware can include a hardware processor 202, memory and/or storage 204, an input device controller 206, an input device 208, display/audio drivers 210, display and audio output circuitry 212, communication interface(s) 214, an antenna 216, and a bus 218, in some embodiments.

Hardware processor 202 can include any suitable hardware processor, such as a graphical processing unit (GPU), a microprocessor, a micro-controller, digital signal processor(s), dedicated logic, and/or any other suitable circuitry for controlling the functioning of a general-purpose computer or a special purpose computer in some embodiments.

Memory and/or storage 204 can be any suitable memory and/or storage for storing programs, data, and/or any other suitable information in some embodiments. For example, memory and/or storage 204 can include: hard disk storage; optical media; Random Access Memory (RAM) (such as dynamic RAM, static RAM, etc.); NAND flash memory; NOR flash memory; any other suitable flash technology; phase change memory technology; and/or other any other suitable volatile and/or non-volatile memory storage technology. Each physical media can have any suitable size in some embodiments.

Input device controller 206 can be any suitable circuitry for controlling and receiving input from input device(s) 208, in some embodiments. For example, input device controller 206 can be circuitry for receiving input from an input device 208 such as a touch screen, from one or more buttons (such as on a keyboard), from a voice recognition circuit, from a microphone, from a camera, from an optical sensor, from an accelerometer, from a temperature sensor, from a near field sensor, and/or any other type of input device.

Display/audio drivers 210 can be any suitable circuitry for controlling and driving output to one or more display/audio output circuitries 212 in some embodiments. For example, display/audio drivers 210 can be circuitry for driving one or more display/audio output circuitries 612, such as an LCD display, a speaker, an LED, a dazzler light, or any other type of output device.

Communication interface(s) 214 can be any suitable circuitry for interfacing with one or more communication networks, such as communication network 104 of FIG. 1. For example, interface(s) 214 can include network interface card circuitry, wireless communication circuitry, and/or any other suitable type of communication network circuitry.

Antenna 216 can be any suitable one or more antennas for wirelessly communicating with a communication network in some embodiments. In some embodiments, antenna 216 can be omitted when not needed.

Bus 218 can be any suitable mechanism for communicating between two or more components 202, 204, 206, 210, and 214 in some embodiments.

Any other suitable components can additionally or alternatively be included in hardware 200 in accordance with some embodiments.

As noted above, in some embodiments, the monitoring/engagement devices can include one or more cameras, one or more light sources, one or more microphones, and one or more speakers, motion sensors, depth sensors, range sensors, direction sensors, battery, and/or any other suitable components. In some embodiments, these mechanisms further include one or more mechanisms, such as motors, servos, or actuators, to cause one or more parts of the monitoring/engagement devices to pan, tilt, and/or zoom.

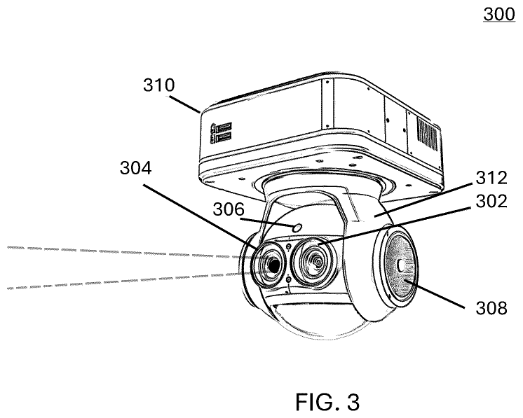

An example 300 of a monitoring/engagement device in accordance with some embodiments is illustrated in FIG. 3. As shown, in some embodiments, device 300 includes a camera 302, a light source 304, a microphone 306, speakers 308, a base 310, and a pan, tilt, zoom (PTZ) mechanism 312. Base 310 can be used to house any one or more of the components shown in and described in connection with FIG. 2, in accordance with some embodiments.

Any suitable camera can be used in a monitoring/engagement device in some embodiments. For example, in some embodiments, a camera used in a monitoring/engagement device can capture color, black and white, infrared, and/or thermal images/video. In some embodiments, a camera used in a monitoring/engagement device can have any suitable resolution, such as 4K resolution or 8K resolution.

Any suitable light source can be used in some embodiments. For example, in some embodiments, a light source can generate targeted light patterns that temporarily impair the vision of a detected threat. As another example, in some embodiments, the light source can generate a high-intensity, directed light beam designed to disorient, irritate, or otherwise disturb a detected threat. As yet another example, in some embodiments, the light source can adjust an intensity and pattern of a light beam so that the beam can be tailored to specific situations and environments. In some embodiments, the light source can generate a light beam that does not cause permanent vision damage to a target. In some embodiments, the light source can generate a focused 2 ft×3 ft (or any other suitable size) beam of high-intensity light to impair the vision of a targeted subject non-lethally.

In some embodiments, the light source can be implemented using one or more SST-70 White 6500K LEDs available from Luminus, Inc. of Sunnyvale, California.

In some embodiments, the microphone can be any suitable microphone. For example, in some embodiments, the microphone can be configured to detect certain sounds such as voices, gun shots, explosions, etc.

The speaker can be any suitable speaker in some embodiments. For example, in some embodiments, the speaker can be configured to play spoken words, to play sirens or other loud sounds, to cause vibrations, etc.

In some embodiments, a hardware processor of a monitoring/engagement device, server, and/or user device can be configured to perform any suitable functions. For example, in some embodiments, the hardware processor can be configured to perform image/video processing, audio input processing, direction determination, range determination, motion detection, light beam shape determination, audio output generation, object detection and/or tracking, object classification, face detection, gaze detection, and/or any other suitable function.

In some embodiment, machine learning, artificial intelligence, and/or one or more classifiers can be used to perform one or more of the functions performed by the hardware processor(s). For example, in some embodiments, machine learning, artificial intelligence, and/or one or more classifiers can be used to perform face detection and/or object detection. Any suitable machine/learning and/or artificial intelligence technology can be used in some embodiments. For example, in some embodiments, neural networks, such as deep neural networks, convolutional neural networks, etc., reinforcement learning algorithms, supervised machine learning algorithms, unsupervised machine learning algorithms, and semi-supervised machine learning algorithms can be used.

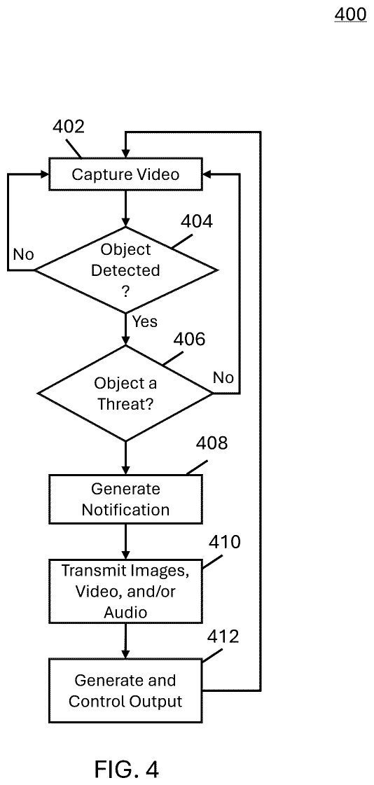

Turning to FIG. 4, an example 400 of a process that can be performed by one or more of a monitoring/engagement device, a server, and a user device in accordance with some embodiments is shown.

As illustrated, at 402, the monitoring/engagement can capture video and/or images of an environment, in some embodiments. Video and/or images can be captured in any suitable manner in some embodiments, and can have any suitable characteristics (such as format, resolution, etc.) and metadata.

Then, at 404, process 400 can determine if an object is detected in the image, in some embodiments. The determination can be made in any suitable manner, in some embodiments. For example, in some embodiments, this determination can be made using a machine learning classifier that has been trained to detect objects, such as people, animals, and/or machines.

If it is determined at 404 that an object has not been detected, then process 400 can loop back to 402.

Otherwise, if it is determined at 404 that an object has been detected, then, at 406, process 400 can determine if the object is a threat. The determination can be made in any suitable manner, in some embodiments. For example, in some embodiments, this determination can be made using a machine learning classifier that has been trained to detect items that constitute threats, such as knives and guns. As another example, in some embodiments, when the object is a person, this determination can be made by performing face recognition on an image of the person, determining that the person is not one of a set of persons authorized to be in the environment, and concluding that the person is a threat.

If it is determined at 404 that an object is not a threat, then process 400 can loop back to 402.

Otherwise, if it is determined at 406 that an object is a threat, then, at 408, process 400 can generate a notification. Any suitable notification can be generated, the notification can be generated in any suitable manner, and the notification can be sent to any suitable user. For example, in some embodiments, the notification can be a message that is generated based on a time and location of the threat, and the notification can be sent as a pop-up message on a user device.

Then, at 410 process 400 can transmit images, video, and/or audio of the environment to the user. Images, video, and/or audio of the environment can be transmitted to the user in any suitable manner, in some embodiments. For example, in some embodiments, images, video, and/or audio of the environment can be transmitted as an audio/video stream from the monitoring/engagement device through the server and onto the user device. This audio/video stream can then be presented to the user using the user device.

At 412, process 400 can generate and control an output from the monitoring/engagement device. Any suitable output can be generated an controlled in some embodiments. For example, in some embodiments, a light source of the monitoring/engagement device can be controlled to generate dazzler light beam to disorient the object. This light beam can be generated and controlled in any suitable manner, in some embodiments. For example, in some embodiments, this light beam can be controlled to have a given beam width, light frequency, pattern, flashing frequency, direction and/or any other suitable characteristics. More particularly, for example, in some embodiments, when the object is a person or animal, the light can be controlled to shine on the object's eyes or face and not to shine elsewhere. This control can take into account the direction and distance of the object from the monitoring/engagement device and any motion of the object. As another example, in some embodiments, a speaker of the monitoring/engagement device can be controlled to output any suitable sound. For example, the speaker can be controlled to generate a deafening siren sound.

After 412, process 400 can loop back to 402.

It should be understood that at least some of the above-described blocks of the process of FIG. 4 can be executed or performed in any order or sequence not limited to the order and sequence shown in and described in the figure. Also, some of the above blocks of the process of FIG. 4 can be executed or performed substantially simultaneously where appropriate or in parallel to reduce latency and processing times. Additionally or alternatively, some of the above described blocks of the process of FIG. 4 5 can be omitted.

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory magnetic media (such as hard disks, floppy disks, and/or any other suitable magnetic media), non-transitory optical media (such as compact discs, digital video discs, Blu-ray discs, and/or any other suitable optical media), non-transitory semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A system for monitoring and engaging threats, comprising:
a camera configured to capture an image;
a hardware processor coupled to the camera; and
a light source coupled to the hardware processor, wherein the hardware processor is configured to at least:
receive the image;
determine that a threat is present in the image; and
in response to determining that the threat is present in the image; cause the light source to illuminate at least part of the threat.

2. The system of claim 1, wherein the camera, the hardware processor, and the light source are contained in a single unit.

3. The system of claim 1, wherein the light source is configured to impair the vision of and/or disorient the threat.

4. The system of claim 1, wherein the hardware processor uses a machine learning algorithm to determine that the threat is present in the image.

5. The system of claim 1, wherein the hardware processor determines that the threat is present in the image by detecting a weapon in the image.

6. The system of claim 1, wherein the hardware processor is also configured to cause light from the light source to target a head region of the threat.

7. A method for monitoring and engaging threats, comprising:
receiving by a hardware processor an image captured by a camera;
determining by the hardware processor that a threat is present in the image;
in response to determining that the threat is present in the image; causing a light source to illuminate at least part of the threat.

8. The method of claim 7, further comprising configuring the light source to impair the vision of and/or disorient the threat.

9. The method of claim 7, wherein determining that the threat is present in the image comprises using a machine learning algorithm to determine that the threat is present in the image.

10. The method of claim 7, wherein determining that the threat is present in the image comprises detecting a weapon in the image.

11. The method of claim 7, further comprising causing light from the light source to target a head region of the threat.

12. A non-transitory computer-readable medium containing computer executable instructions that, when executed by a processor, cause the processor to perform a method for monitoring and engaging threats, the method comprising:
receiving an image captured by a camera;
determining by the hardware processor that a threat is present in the image;
in response to determining that the threat is present in the image; causing a light source to illuminate at least part of the threat.

13. The non-transitory computer-readable medium of claim 7, wherein the method further comprises configuring the light source to impair the vision of and/or disorient the threat.

14. The non-transitory computer-readable medium of claim 7, wherein determining that the threat is present in the image comprises using a machine learning algorithm to determine that the threat is present in the image.

15. The non-transitory computer-readable medium of claim 7, wherein determining that the threat is present in the image comprises detecting a weapon in the image.

16. The non-transitory computer-readable medium of claim 7, wherein the method further comprises causing light from the light source to target a head region of the threat.
